(19) United States
(12) Patent Application Publication
(10) Pub. No.: US 2006/0104270 A1
(43) Pub. Date: May 18, 2006

(54) Method and apparatus for communicating within a segmented network

(76) Inventors: Inching Chen, Portland, OR (US); Benjamin Manny, Portland, OR (US); Stephen S. Pawlowski, Beaverton, OR (US)

Correspondence Address: INTEL CORPORATION, P.O. BOX 5326, SANTA CLARA, CA, 95056-5326, US

(21) Appl. No.: 10/989,778

(22) Filed: Nov. 16, 2004

(51) Int. Cl. H04L 12/56; H04L 12/28

(52) U.S. Cl. 370/389

(57) ABSTRACT

A method and apparatus for communicating within a segmented network are generally disclosed.

### TECHNICAL FIELD

Embodiments of the invention are generally directed to communicating within or between electronic systems and, more particularly, to a method and apparatus for multicasting/broadcasting in a segmented network.

### BACKGROUND

Nodes within a network may occasionally experience the need to broadcast or multicast a message to other node(s) in network(s) to which the node is coupled. As used herein, a broadcast operation refers to a node transmitting one or more datagram(s) (e.g., packet, frame, burst, byte, bit, word, dword, etc.) comprising the message to an entire group of nodes within a network; while multicasting refers to sending the one or more datagram(s) comprising the message to only a select subset of such nodes.

For networks in which nodes are coupled through a shared communication medium, e.g., Ethernet networks with IEEE 802.3 CSMA/CD (carrier sense multiple access/collision detect), broadcast and multicast operations are easily completed by simply transmitting the message to the shared communication medium, at which point the message is available to all other nodes coupled to the shared medium. However, for networks that do not use a shared communication medium, these operations are not so easily completed.

As the definition of network is expanded to include ad-hoc networks wherein communication is dynamically established through point-to-point links, or networks in which nodes are coupled through segmented communication media (e.g., a mesh network), the conventional techniques for completing broadcast and/or multicast operations are rendered ineffective. Multicast and broadcast operations on such a network typically rely on replication (or, relay) of a broadcast packet to reach a group of nodes. How the broadcast packet is replicated/relayed may vary depending on the specific implementation of the network, and may include such factors as absolute/relative addressing of nodes, source/destination routing, routing algorithms, and legacy transmission capability (e.g., unicast limitations).

### BRIEF DESCRIPTION OF THE DRAWINGS

Embodiments of the present invention are illustrated by way of example, and not by way of limitation, in the figures of the accompanying drawings in which like reference numerals refer to similar elements and in which:

FIG. 1 is a block diagram of an example mesh network, within which embodiments of the invention may be implemented;

FIG. 2 is a flow chart of an example method for performing broadcast and/or multicast operations between nodes in a segmented communication network;

FIG. 3 is a flow chart of an example method for routing datagrams within a segmented communication network, according to one embodiment;

FIG. 4 is a block diagram of an example hardware implementation for performing packet processing, according to but one example embodiment of the invention; and

FIG. 5 is a block diagram of an example article of manufacture including content which, when executed by an accessing machine, causes the machine to implement one or more aspects of embodiment(s) of the invention.

### DETAILED DESCRIPTION

Embodiments of a method and apparatus for communicating within a segmented network are generally introduced. In particular, embodiments of a method and apparatus for performing broadcasting and/or multicasting operations within a segmented network of nodes characterized by a legacy unicast architecture and using relative addressing, is generally presented. According to one embodiment, an innovative hierarchical-fanning transmission protocol is introduced through which a broadcast or multicast operation is completed through successive iterations of unicast messaging.

According to an example embodiment of the hierarchical-fanning transmission protocol, a source node may transmit a datagram to a node along a first axis (e.g., negative-y), before transmitting to a node along a second axis (e.g., positive-x) of a network topology. Each of the nodes along the first axis will perform in exactly the same way as the source node (e.g., transmission first along the first axis prior to transmission along the second axis) until the intended recipient nodes have received the datagram. Conversely, nodes along the second axis may further propagate the datagram to additional nodes along one axis (e.g., the second axis) until the desired recipient nodes along such axis have received the datagram. In this way, the datagram propagates in a south-easterly fashion, wrapping around edges of the respective axes as necessary, until the broadcast or multicast datagram has been propagated throughout the network.

It will be shown that the hierarchical-fanning transmission protocol enables a network of nodes constrained to unicast communication restrictions to broadcast or multicast a datagram throughout a desired network in a reduced (e.g., minimal) number of “hops” (or, steps of replication/relay between the source and destination(s)).

For purposes of illustration, and not limitation, a few contextual definitions are provided although the scope of the invention is not intended to be limited to, or by, such definitions. As used herein, networked nodes may refer to any group of two or more nodes that are interconnected so as to be capable of sharing information provided by a common source, and/or SO as to be able to transmit information to a common destination. In this regard, the common source or common destination may be one or more of a memory, a network, a router, a switch, another processor and the like, although the invention is not limited in this regard. In some embodiments, networked nodes may be co-located on a die and/or a motherboard. In some embodiments, networked nodes may form part of a global information network.

Relative addressing refers to a nomenclature wherein the location of a destination node is represented as the number of segments, or hops, between the source node and the destination node. In a two-dimensional mesh network for example, an “address” of a destination node may be represented by the number of segments (or, hops) between the source and destination in each of the x- and y-axis, although the scope of the invention is not so limited.

As used herein, unicast refers to a constraint where communication is limited from a sending node to a single receiver node at any given time. According to one embodiment of the segmented network implementation, this constraint is illustrated by a node being able to only transmit along one axis of the topology at a time. Notwithstanding the foregoing, those skilled in the art will appreciate that the hierarchical-fanning transmission protocol is not limited to implementation in unicast network environments, and that other network topologies will similarly benefit from the teachings introduced herein.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

Example Network Environment

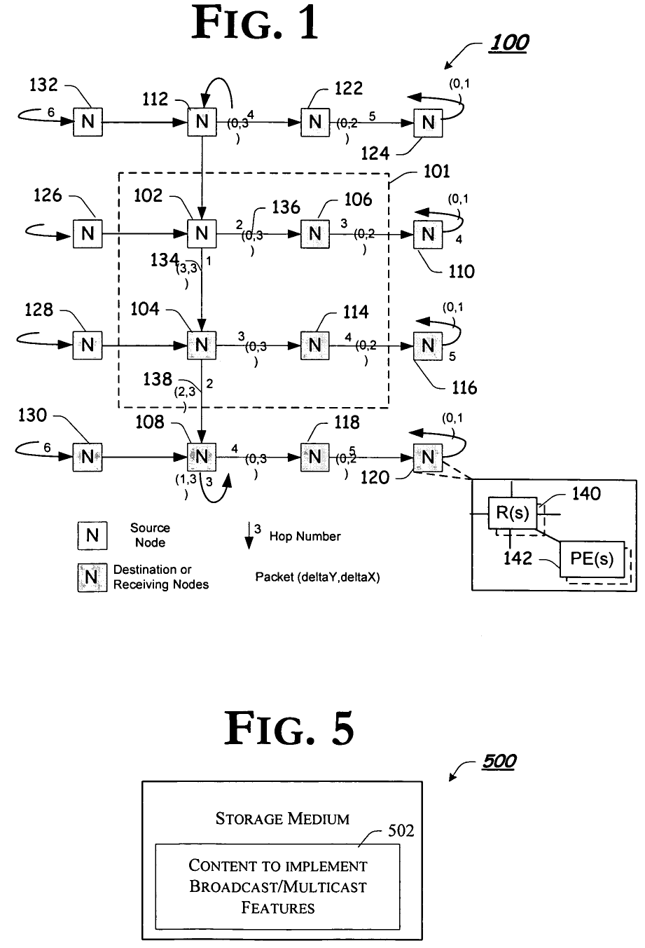

FIG. 1 illustrates a block diagram of an example segmented communication network 100 of nodes within which embodiments of the invention may well be practiced. In particular, FIG. 1 is depicted comprising a plurality of networked nodes 102-132 selectively coupled to one another through a segmented interconnect of communication paths (e.g., a mesh network), as shown. According to one embodiment, network 100 may use relative addressing when communicating between a source node and a destination node. It will be appreciated that, although a 4×4 mesh network of sixteen (16) nodes is depicted, embodiments of the invention may well be applied to networks of greater or lesser complexity without deviating from the spirit and scope of the present invention. For purposes of illustration, and not limitation, a broadcast operation refers to the communication of a datagram among all of the plurality of nodes 102-132, while a multicast operation refers to the communication of a datagram to a subset (e.g., 101) of nodes, although the invention is not limited in this regard.

According to one embodiment, at least a subset of nodes 102-132 may include one or more processing element(s) (PE) (142) and router(s) (R) (140), although the scope of the invention is not limited in this regard. But for the introduction of the novel hierarchical-fanning transmission protocol to implement broadcast and/or multicast operations described herein below, conventional processing element(s) (142) and/or conventional router(s) (140) may well be utilized within any one or more of nodes 102-132.

According to one embodiment (not particularly illustrated), a node may be comprised of a sub-mesh of nodes. In this regard, according to one example embodiment, network 100 may actually represent one node comprising a sub-mesh 102-132 for a higher-level network of nodes (not particularly illustrated), although the invention is not limited in this regard. In such an implementation, a broadcast or a multicast operation received by the node would initiate a broadcast or a multicast operation within the sub-mesh of nodes. Thus, it should be appreciated that the innovative hierarchical fanning transmission protocol may be beneficially implemented in any of a number of network topologies to reduce, perhaps to a minimum, the number of hops required to complete broadcast or multicast operations.

In some embodiments, the routers (140) may be coupled with the processing elements (142) in a 1:1 fashion, a many:1 fashion, a 1:many fashion or a many:many fashion. According to one embodiment, the routers (140) of nodes 102-132 may include a plurality of synchronously clocked routers, perhaps clocked by a single clocking source, although the scope of the invention is not so limited. In this regard, information may travel between any adjacent nodes 102-132 in a single clock pulse. As shown in FIG. 1, each segment of the network includes a hop number (1 . . . 6) denoting which hop instance the datagram was transmit between neighboring nodes, and also the (delta-y, delta-x) values of the datagram.

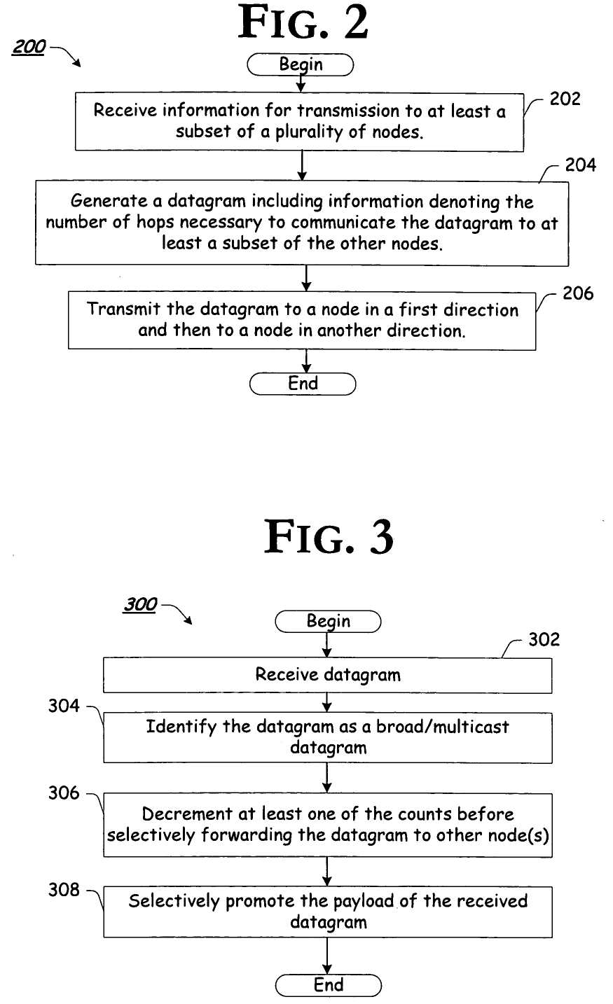

As will be developed more fully in conjunction with FIGS. 2 and 3, at least a subset of nodes 102-132 may implement the hierarchical-fanning transmission protocol for broadcasting and/or multicasting a datagram between a source (e.g., 102) and a destination (e.g., two or more of 104-132) in an efficient (e.g., minimum) number of hops. According to one implementation, where the nodes are coupled to communicate in the x-y fashion depicted in FIG. 1, implementation of the technique described herein enables a node to issue a datagram throughout an M×N network of nodes in (M+N-2) hops. So, for a 4×4 mesh depicted in FIG. 1, it will take six (6) hops (i.e., 4+4-2) to issue a datagram from node 102 throughout nodes 104-132 of network 100. In various implementations, e.g., a network topology using relative addressing and constrained to sequential unicast communications, the M+N-2 number of hops may represent a minimum number of hops necessary to communicate the datagram to the desired recipient nodes.

Those skilled in the art will appreciate that the hierarchical fanning transmission protocol may well be implemented in other network architectures. According to one example embodiment, in addition to the communication links in the x-y direction depicted in FIG. 1, the nodes in the network may also include a communication link in one or more diagonal (i^{th}) directions. In yet another embodiment, nodes coupled in a star network topology that implement the hierarchical fanning transmission protocol detailed herein facilitates a broadcast (e.g., to all the M nodes) in some number less than M+N-2 hops (e.g., M hops). In this regard, according to some embodiments, the hierarchical-fanning transmission protocol reduces (perhaps to a minimum) the number of hops necessary to prorogate a datagram throughout a multicast or broadcast region of nodes in a network.

As introduced above, network 100 may well be implemented within one or more silicon device(s) (e.g., system on chip, multi-core processor, reconfigurable device, etc.); within a single card (e.g., motherboard, server blade, etc.); within a single computing and/or communication system (e.g., cell phone, laptop, desktop, personal digital assistant, etc.); and/or within a broader network, although the scope of the invention is not limited as such.

With continued reference to FIG. 1, attention is now directed to FIG. 2, where a flow chart of an example method for initiating a broadcast or multicast transmission with network 100 is depicted according to but one example embodiment. According to one example embodiment, the method of FIGS. 2 and/or 3 may be implemented by router(s) (140) associated with(in) node(s) 102-132, although the invention is not limited in this regard.

In accordance with the illustrated example embodiment of FIG. 2, the method begins with block 202 wherein a node (e.g., 102) deems it appropriate to initiate a broadcast or multicast of a datagram. For example, a processor element (142) associated with the node may receive content from an application (e.g., executing on a host) or another node with an indication to initiate a broadcast of a datagram to the nodes of network 100, or a multicast to a subset thereof. According to one embodiment, the source node (102) is provided with the number of nodes in the desired communication region (broadcast or multicast) of network 100 in order to generate the datagram. In such an embodiment, the source node (102) computes the number of hops necessary to communicate the datagram throughout the desired set of recipient nodes according to the hierarchical-fanning transmission protocol as M-1, N-1, where M is the number of nodes along the y-axis and N is the number of nodes along the x-axis.

In some embodiments, the source node is simply provided with the number of hops necessary in accordance with the hierarchical-fanning transmission protocol. In some embodiments, the source node (102) may determine the number of hops necessary to communicate a broadcast or multicast message by dynamically determining its relative position within the desired set of recipient nodes, e.g., by ranging or calibration techniques. According to an example ranging technique, the source node may issue a ranging datagram designed to “count” the number of hops necessary along each axis to return to the source of the ranging datagram. According to one embodiment, the “count” merely increments with each hop along each axis until the datagram is received back at the source node.

In block 204, the source node may generate a datagram including information regarding the hops necessary to communicate the datagram to at least a subset of the nodes of network 100. According to one embodiment, the processing element (142) of the node (102) generates a packet (an example form of datagram) that may include a header portion and a payload portion, although the invention is not limited in this regard.

According to one embodiment, the header portion may include one or more fields in which the number of hops required in each dimension of the network topology, e.g., a delta-x, delta-y and/or delta-z field, although the invention is not limited in this regard. In some embodiments, the number of hops required in each direction of the network topology is (N-1), where N is the number of nodes in that direction of the topology. Thus, in the 4×4 example illustrated herein, delta-y and delta-x would be represented as (delta-y,delta-x) or (3,3) in the header of the datagram (also denoted along each segment of FIG. 1). According to one embodiment, a conventional header/data packet format may well be used as the datagram referenced herein. Once generated, processor element (142) passes the packet to router (140) for transmission in accordance with the hierarchical-fanning transmission protocol discussed below.

In block 206, the source node may transmit the datagram to a neighboring node in a first direction of the network topology, followed by transmission to a neighboring node in a second direction of the network topology. In this regard, source node 102 may issue a broadcast packet with a header denoting (3,3) to a neighboring node in the “south” (or, negative-y direction of the two-dimensional network topology) (e.g., node 104). In the hierarchical-fanning transmission protocol, transmission to nodes in the south (bottom) are prioritized over transmission to nodes in the east (right), although other transmission hierarchies may well be used.

Simultaneously or thereafter, the source node 102 will issue a broadcast packet with delta-y=0 and delta-x=3 (0,3) to the “east” (or, the positive-x direction of the two-dimensional network topology). According to one embodiment, the transmission of the datagram from the source node 102 to node 106 in the positive-x direction from node 102 occurs within the same clock cycle of transmission of a modified datagram from node 104 to node 108. The datagram will then be propagated throughout the desired broadcast or multicast network in a southeasterly fashion on subsequent clock pulses applied to the respective nodes 110-132, as shown. An example method for propagating the broadcast packet is provided below, with reference to the flow chart of FIG. 3.

Turning to FIG. 3, with continued reference to FIGS. 1 and 2, an example method for propagating a broadcast packet throughout a segmented network is provided, according to one example embodiment. As shown, the method of FIG. 3 picks up where the method of FIG. 2 leaves off, i.e., with the processing of the broadcast datagram in the nodes of the network 100 after it has been issued from the source node 102, although the invention is not limited in this regard.

In block 302, a datagram is received at a receiving node (e.g., node 104) from a neighboring node (e.g., 102). In block 304, a router associated with (or, within) the receiving node 104 may identify the received datagram as a broadcast datagram. As a broadcast datagram, the received datagram is intended for consumption by node 104 as well as at least a subset of other nodes 106-132, which may require node 104 to further propagate the datagram. According to one embodiment, the received datagram may include an indication that it is a broadcast datagram, although the invention is not limited in this regard.

In block 304, the receiving node (104) may determine whether to selectively forward the datagram to neighboring node(s). According to one embodiment, a router (140) associated with the receiving node (104) may examine the datagram (e.g., one or more of the header, footer, midamble, payload, etc.) to determine whether the receiving node represents the final hop in the broadcast. In the context of a two-dimensional network topology (e.g., FIG. 1), the receiving node (104) may analyze the header of the datagram to identify the delta-y and delta-x values denoted therein. If they are both zero, the receiving node represents the last hop in the broadcast or multicast communication, and no further transmission is required. In the context of FIG. 1, node 104 is merely the first hop of the broadcast stemming from source node 102. As such, the delta-y and delta-x values are each set to three (3, 3).

According to one embodiment, if delta-y does not equal zero, the router (140) may decrement the delta-y value by one (1). The node (104) may then transmit the datagram to a neighboring node in the south (negative-y direction) (element 138) with a modified header representing the decremented delta-y value (e.g., (2,3)), although the scope of the invention is not limited in this regard. As introduced above, this transmission (138) may occur substantially simultaneously with transmission (136) from node 104 (each denoting a hop number of 2).

Substantially simultaneously or thereafter in node 104, if delta-x of the received datagram does not equal zero, the router (140) will set the delta-y value to zero (0) to generate a modified header (0,3). Node 104 may then transmit a version of the received datagram to a neighboring node (114) in the east (positive-x direction) with the modified header representing the decremented delta-x value (e.g., (0,3)), although the scope of the invention is not limited in this regard. When this datagram is received by subsequent nodes along the x-axis, the node will decrement the header (e.g., delta-x value by 1) and forward the datagram to a subsequent node in the x-direction, wrapping around network edges as necessary, until the header denotes that no further hops are necessary (e.g., 0,0).

In block 308, recognizing that the received datagram is a broadcast packet (i.e., intended for multiple recipients including the receiving node 104.), at least a subset of any payload may be promoted (reviewed and/or executed) by one or more of the router 140 or processing element 142 associated with the receiving node (104).

Summarizing the illustrated embodiment of the hierarchical-fanning transmission protocol in the two-dimensional network architecture of FIG. 1, a source node will generate a datagram and first transmit it along the y-axis (e.g., negative-y axis) with a header denoting (M-1, N-1) representing the number of hops required in each of the y- and x-axes. The source node may then transmit a datagram along the x-axis or subsequent axis, where the delta-y value is set to zero while the delta-x value is set to (N-1). Subsequent nodes along the y-axis will decrement the delta-y value, while maintaining the delta-x value and prioritize transmission to southern nodes prior to transmission to eastern nodes. Subsequent nodes along an x-axis will set the delta-y value to zero (if not done already), and will decrement the delta-x value to reflect the number of hops from the y-axis source.

In some embodiments, as datagrams reach a network edge along the axes (e.g., node 108, or nodes 110, 116, 120, 124) the datagrams may “wrap” around the axes to nodes 112, 126, 128, 130 and 132, respectively, as appropriate.

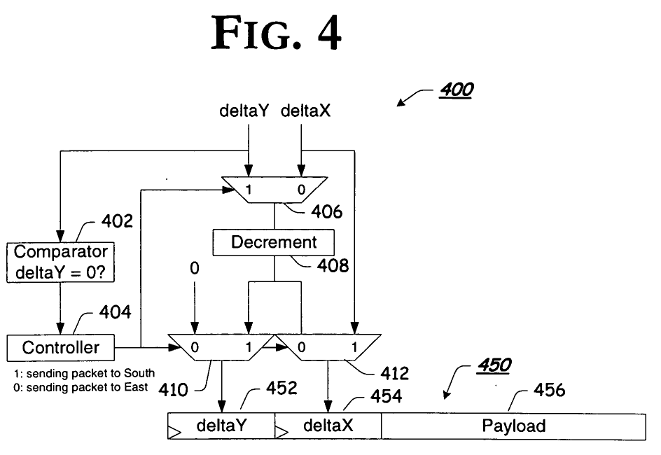

FIG. 4 is a block diagram of an example datagram header processor suitable for use in a router of one or more nodes (102-132) of FIG. 1, according to one embodiment. According to the example embodiment, a first of the hop values (e.g., delta-y) is received at a comparator 402, where a determination is made whether the first hop value is zero. The output of the comparator is provided to control logic (e.g., controller 404), which may selectively control a header generation architecture comprising three multiplexers 406, 410 and 412 and an element 408 that decrements by one (e.g., a subtraction element), as shown.

According to one example embodiment, if the controller 404 determines that the delta-y value is zero, controller sends an indication to at least a subset of the header generation architecture that the packet is to be merely transmitted to an east neighboring node if the delta-x value is not zero as well. Alternatively, if the delta-y value is not zero, controller 404 may send an indication to at least a subset of the header generation architecture that the packet is to be merely transmitter to a south-neighboring node. In response, the header generation architecture generates hop values for populating the header elements (e.g., 452 and 454) of a datagram 450, as shown. According to one embodiment, introduced above, the datagram 450 is depicted comprising a payload 456 which may include zero or more bits.

### Alternate Embodiment(s)

FIG. 5 illustrates a block diagram of an example storage medium comprising content which, when invoked, may cause an accessing machine to implement one or more aspects of the broadcast/multicast technique(s) of FIGS. 2-4. In this regard, storage medium 500 may include content 502 (e.g., instructions, data, or any combination thereof) which, when executed, causes an accessing appliance to implement one or more of the broadcast/multicast features described herein.

The machine-readable (storage) medium 500 may include, but is not limited to, floppy diskettes, optical disks, CD-ROMs, and magneto-optical disks, ROMs, RAMs, EPROMs, EEPROMs, magnet or optical cards, flash memory, or other type of media / machine-readable medium suitable for storing electronic instructions. Moreover, various embodiments may be downloaded as a computer program product, wherein the program may be transferred from a remote computer to a requesting computer by way of data signals embodied in a carrier wave or other propagation medium via a communication link (e.g., a modem, radio or network connection). As used herein, all of such media is broadly considered storage media.

It should be understood that various embodiments may be used in a variety of applications. Although the present invention is not limited in this respect, the architecture and method(s) disclosed herein may be used in many apparatuses such as in the control element(s), transmitter(s) and/or receiver(s) of a wireless communication or computing system. Systems intended to be included within the scope of the present invention include, by way of example only, wireless local area networks (WLAN) devices and wireless wide area network (WWAN), wireless personal area network (WPAN) and cellular or wireless broadband telephony network devices. Such devices may include wireless network interface devices and network interface cards (NICs), base stations, access points (APs), gateways, bridges, hubs, cellular radiotelephone communication systems, satellite communication systems, two-way radio communication systems, one-way pagers, two-way pagers, personal communication systems (PCS), personal computers (PCs), personal digital assistants (PDAs), sensor networks, digital broadband telephony device(s), computing devices and the like, although the scope of the invention is not limited in this respect. According to one embodiment, the network 100 represents a multi-core processor, responsive to one or more antennae to receive and process wireless communication signals in any of a number of wireless communication devices. According to various embodiments, the antenna(e) may well be one or more of substantially dipole antenna(e), omnidirectional atenna(e), etc., although the scope of the invention is not limited in this regard.

The present invention includes various operations. The operations of the present invention may be performed by hardware components, such as those shown in FIGS. 1 and/or 4, or may be embodied in machine-executable content (e.g., instructions) 502, which may be used to cause a general-purpose or special-purpose processor or logic circuits programmed with the instructions to perform the operations. Alternatively, the operations may be performed by a combination of hardware and software.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Any number of variations of the inventive concept are anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. A method for communicating a datagram throughout a desired set of two or more recipient nodes in a segmented communication network topology, the method comprising:
generating a datagram including an indication denoting a number of hops necessary in at least a subset of axes of the network topology to propagate the datagram to the desired set of recipient nodes; and
propagating the generated datagram throughout the desired set of recipient nodes according to a hierarchical-fanning transmission protocol that reduces a total number of hops necessary to complete a broadcast or multicast communication operation throughout the desired set of recipient nodes.

2. A method according to claim 1, wherein the hierarchical-fanning transmission protocol enables the propagation throughout an M×N network of nodes in M+N-2 hops.

3. A method according to claim 2, the element of generating a datagram comprising:
populating a header of the datagram with the number of hops, (delta-y, delta-x).

4. A method according to claim 3, the hierarchical-fanning transmission protocol, implemented at each node of the network, comprising:
determining whether there remain any hops necessary along a first axis; and
if so, modifying the header accordingly and transmitting a datagram with the modified header to a neighboring node along the first axis.

5. A method according to claim 4, the element of determining whether any hops remain along the first axis comprising determining whether the delta-y value is set to zero (0).

6. A method according to claim 4, the element of modifying the header comprising:
decrementing the header value denoting the number of hops remaining along the first axis by one (1), while leaving the header value denoting the number of hops remaining in the second direction as received; and
transmitting the datagram with the modified header to the neighboring node along the first axis.

7. A method according to claim 6, the hierarchical-fanning transmission protocol further comprising:
determining whether there remain any hops necessary along a second axis;
if so, decrementing the header value denoting the number of hops remaining along the second axis by one (1), and setting the number of hops remaining along the first axis to zero (0); and
transmitting the datagram with the modified header to the neighboring node in the second direction.

8. A method according to claim 7, the element of determining whether any hops remain along the second axis comprising determining whether delta-x is set to zero (0).

9. A method according to claim 1, wherein the hierarchical-fanning transmission protocol is implemented within a router of each node of the segmented network.

10. A method according to claim 1, wherein the segmented network of nodes is a mesh network.

11. A method according to claim 1, wherein the segmented network of nodes is implemented in one or more of a reconfigurable device, a multi-core device, or processor device within an electronic appliance.

12. A method according to claim 1, wherein nodes in the network are coupled for communication along an x-axis, y-axis as well as one or more diagonal direction(s), comprising:
implementing a hierarchical fanning transmission protocol to enable communication to at least a subset of M nodes in less than M+N-2 hops.

13. A machine readable medium comprising content that, when accessed by an electronic device, causes the device to implement a method for broadcasting a datagram throughout a segmented communication network of nodes, the method including,
generating a datagram including an indication denoting a number of hops necessary in at least a subset of axes of the network topology to propagate the datagram to the desired set of recipient nodes; and
propagating the generated datagram throughout the desired set of recipient nodes according to a hierarchical-fanning transmission protocol that reduces a total number of hops necessary to complete a broadcast or multicast communication operation throughout the desired set of recipient nodes.

14. An article of manufacture according to claim 13, wherein the hierarchical-fanning transmission protocol enables the propagation throughout an M×N network of nodes in M+N-2 hops.

15. An article of manufacture according to claim 14, the method further comprising:
populating a header of the datagram with the number of hops, (delta-y, delta-x).

16. An article of manufacture according to claim 15, wherein the hierarchical-fanning transmission protocol, implemented at each node of the network, comprises:
determining whether there remain any hops necessary along a first axis; and
if so, modifying the header accordingly and transmitting a datagram with the modified header to a neighboring node along the first axis.

17. An article of manufacture according to claim 16, the element of determining whether any hops remain along the first axis comprising determining whether the delta-y value is set to zero (0).

18. An article of manufacture according to claim 19, the element of modifying the header accordingly comprising:
decrementing the header value denoting the number of hops remaining along the first axis by one (1), while leaving the header value denoting the number of hops remaining along the second axis as received; and
transmitting a datagram with the modified header to the neighboring node along the first axis.

19. An article of manufacture according to claim 18, the hierarchical-fanning transmission protocol further comprising:
determining whether there remain any hops necessary along the second axis;
if so, decrementing the header value denoting the number of hops remaining along the second axis by one (1), and setting the number of hops remaining along the first axis to zero (0); and
transmitting a datagram with the modified header to the neighboring node along the second axis.

20. An article of manufacture according to claim 19, the element of determining whether any hops remain along the second axis comprising determining whether delta-x in the received datagram is set to zero (0).

21. An article of manufacture according to claim 13, wherein the hierarchical-fanning transmission protocol is implemented within a router of each node of the network.

22. An article of manufacture according to claim 13, wherein the segmented network of nodes is a mesh network.

23. An article of manufacture according to claim 13, wherein nodes in the network are coupled for communication along an x-axis, y-axis as well as one or more diagonal direction(s), further comprising content which when executed cause the device to implement a hierarchical fanning transmission protocol to enable communication to at least a subset of M nodes in less than M+N-2 hops.

24. An apparatus comprising:
a segmented network of nodes, each node comprising one or more router(s) associated with one or more processing element(s), wherein the nodes use a hierarchical-fanning transmission protocol that reduces a total number of hops necessary to complete a broadcast or multicast communication operation throughout a desired set of two or more recipient nodes within the segmented network of nodes.

25. An apparatus according to claim 24, wherein the hierarchical-fanning transmission protocol issues datagrams along a first topology axis, before transmitting datagrams along a second and subsequent topology axes.

26. An apparatus according to claim 24, one or more of the node(s) comprising:
a router, communicatively coupled with at least two communication links between two other nodes to transmit and receive datagrams therebetween; and
a processing element, responsive to the router, to selectively transmit/receive select datagrams to/from the at least two communication links;
wherein the router implements the hierarchical-fanning transmission protocol.

27. An apparatus according to claim 26, wherein the router, implementing the hierarchical-fanning transmission protocol, determines whether there remain any hops necessary along a first axis and, if so, modifies a header accordingly and transmits a datagram with the modified header to a neighboring node along the first axis.

28. An apparatus according to claim 27, wherein the router, implementing the hierarchical-fanning transmission protocol, determines whether any hops remain along the first axis by determining whether the delta-y value in the received datagram is set to zero (0).

29. An apparatus according to claim 28, wherein the router modifies the header by decrementing the header value denoting the number of hops remaining along the first axis by one (1), while leaving the header value denoting the number of hops remaining along the second axis as received.

30. An apparatus according to claim 29, wherein implementing the hierarchical-fanning transmission protocol, the router determines whether there remain any hops necessary along the second axis and, if so, decrements the header value denoting the number of hops remaining along the second axis by one (1) and sets the number of hops remaining along the first axis to zero (0) and transmits the datagram with the modified header to the neighboring node along the second axis.

31. An apparatus according to claim 24, one or more nodes of the network comprising:
a sub-mesh network of nodes, wherein a broadcast or multicast operation received by the one or more nodes initiates a broadcast operation within the sub-mesh network of nodes.

32. An apparatus according to claim 24, wherein the nodes are coupled for communication along an x-axis, y-axis as well as one or more diagonal direction(s), wherein the nodes selectively implement a hierarchical fanning transmission protocol to enable communication to at least a subset of M nodes in less than M+N-2 hops.

33. A system comprising:
one or more substantially omnidirectional antenna(e), through which a wireless communication channel is selectively established and maintained with a remote device; and
a segmented network of nodes, each node comprising one or more router(s) associated s with one or more processing element(s), wherein the nodes use a hierarchical-fanning transmission protocol that reduces a total number of hops necessary to complete a broadcast or multicast communication operation throughout a desired set of two or more recipient nodes within the segmented network of nodes.

34. A system according to claim 33, wherein the hierarchical-fanning transmission protocol issues datagrams along a first topology axis, before transmitting datagrams along a second and subsequent topology axis.

35. A system according to claim 33, one or more node(s) comprising:
a router, communicatively coupled with at least two communication links between two other nodes to transmit and receive datagrams therebetween; and
a processing element, responsive to the router, to selectively transmit/receive select datagrams to/from the at least two communication links;
wherein the router implements the hierarchical-fanning transmission protocol.

36. A system according to claim 35, wherein the router, implementing the hierarchical-fanning transmission protocol, determines whether there remain any hops necessary along a first axis and, if so, modifies the header accordingly and transmits the datagram with the modified header to a neighboring node along the first axis.

37. A system according to claim 36, wherein the router, implementing the hierarchical-fanning transmission protocol, determines whether any hops remain along the first axis by determining whether the delta-y value in the received datagram is set to zero (0).

38. A system according to claim 37, wherein the router modifies the header by decrementing the header value denoting the number of hops remaining along the first axis by one (1), while leaving the header value denoting the number of hops remaining along the second axis as received.

39. A system according to claim 38, wherein the router, implementing the hierarchical-fanning transmission protocol, determines whether there remain any hops necessary along a second axis and, if so, decrements the header value denoting the number of hops remaining along the second axis by one (1), sets the number of hops remaining along the first axis to zero (0) and transmits the datagram with the modified header to the neighboring node along the second axis.

40. A system according to claim 33, wherein the nodes are coupled for communication along an x-axis, y-axis as well as one or more diagonal direction(s), wherein the nodes selectively implement a hierarchical fanning transmission protocol to enable communication to at least a subset of M nodes in less than M+N-2 hops.
